(19) United States
(12) Patent Application Publication
(10) Pub. No.: US 2001/0026447 A1
(43) Pub. Date: Oct. 4, 2001

(54) Device for connecting a light-emitting diode to a lampholder provided with resilient contacts

(76) Inventor: Ricardo Romero Herrera, S.Climent De Llobregat (ES)

Correspondence Address: JACOBSON HOLMAN PLLC, 400 SEVENTH STREET N.W., SUITE 600, WASHINGTON, DC, 20004, US

(21) Appl. No.: 09/764,362

(22) Filed: Jan. 19, 2001

(30) Foreign Application Priority Data
Jan. 19, 2000 (ES) 200000203

(51) Int. Cl. H01R 33/00

(52) U.S. Cl. 362/226; 362/800; 313/318.05; 257/99

(57) ABSTRACT

A device for connecting a light-emitting diode to a lampholder provided with resilient contacts.

Said lampholder being of the type adapted to receive incandescent lamps comprised of glass-bulb with flattened tail from which connecting pins extend. The device comprises a dielectric member (1) including a first hollow portion (2) and a second portion (3) externally reproducing configurations of said flattened tail, said first portion (2) communicating with passages (4) longitudinally extending through said second portion (3). Said member (1) is fitted to a LED (5) comprising round-ended (7) cylindrical body (6) with a flat surface (8) at the other end from which two connecting pins (9) extend and are passed through said first portion (2) and passages (4), said first portion (2) abutting said surface (8) and said pins (9) being bent upon one side of second portion (3) thus resulting in an assembly being apt to be press-fit connected to said lampholder.

The present invention concerns a device for connecting a light-emitting diode to a lampholder provided with resilient contacts and apt to be used in association with an electric cutout pushbutton, and more specifically in association with a miniature electric cutout pushbutton with internal lighting.

For example gaming machines are usually equipped with electric cutout pushbuttons provided with lighting means in their inside, said lighting means being either associated to the connection terminals of the cutout, in which case they are indicative of this latter's open or closed state, or being independent from said open or closed state of the cutout, in which case they are permanently on or obey other switching on/off sequences having been for example programmed.

U.S. Pat. No. 5,543,594 discloses an electric cutout provided with a pushbutton housing a lamp in its inside. Said lamp is an incandescent lamp of miniaturized size of the type comprising a glass-bulb in whose inside there is a glowing filament connected to a pair of contact pins projecting from said bulb through a flattened tail being also made of glass and integrally formed at one end of the bulb. A lampholder is securely fitted to the base of the cutout and comprises a hole in whose inside resilient contact members are arranged which are connected to the terminals of the cutout and are adapted to be resiliently applied against the sides of said flattened tail of the incandescent lamp.

The lamp pins are for their assembly cut to an adequate length and are then bent towards the bulb to be thus superimposed on one of the sides of said flattened tail, and the lamp is then press-fitted into said hole whereby said contact members grip the lamp at said flattened tail thereby establishing electric contact with said cutout terminals. This flattened tail of this type of lamps for such a purpose has characteristic configurations making it apt for this use and furthermore allowing to successively connect and disconnect the lamp in a press-fit in an easy and quick way and as many times as necessary.

Incandescent lamps do nevertheless have several drawbacks such as a relatively elevated power consumption, a relatively short service life and a tendency to heat up, and hence they are not very apt to operate in small enclosures such as a pushbutton, since the lack of ventilation leads to their heating up in excess and to a limited life span.

There is at present a tendency to use light-emitting diodes, usually called in short LED's as per the English abbreviation, due to their having a sensibly lower energy consumption and a more prolonged life span as compared with the incandescent lamps, without their having a tendency to heat up to an undesirable extent, to which has to be added that they are besides commercially available at a reduced cost. Said light-emitting diodes being commercially available at a reasonable price are nevertheless carried out as per a configuration consisting of a cylindrical body capped at an end by a segment of a sphere and at the other end ending in a flat surface from which two contact pins extend, said diodes not having the flattened tail being characteristic of the incandescent lamps described above and hence not being apt to be quickly and in a press-fit connected/disconnected to/from a lampholder provided with resilient contacts These light-emitting diodes are on the contrary generally connected in a permanent manner by soldering, this to a great extent rendering difficult the successive connections and disconnections of such a diode.

The present invention does therefore have as its object to provide a device for connecting a light-emitting diode to a lampholder provided with resilient contacts, said device being apt to be used in association with an electric cutout pushbutton, and more specifically in association with a miniature electric cutout pushbutton with internal lighting to thus allow to in a press-fit and as many times as desired connect/disconnect said light-emitting diode to/from a lampholder provided with resilient contacts and adapted to be used with incandescent lamps with a flattened tail of conventional type.

According to the instant invention this object is attained by providing a member made of a dielectric material such as plastics and externally reproducing the configurations being characteristic of the flattened tail and of part of the bulb of an incandescent lamp of the type for which the lampholder with resilient contacts is adapted. Passages provided for said connecting pins of the light-emitting diode longitudinally extend through that portion of said member which reproduces the flattened tail, whereas that portion of said member which reproduces part of the bulb is hollow and communicates with said passages, in such a way that a light-emitting diode can be fitted to said member by passing the connecting pins first through said hollow portion and then through the corresponding passages till the open top of the hollow portion of said member abuts against said flat surface of the light-emitting diode. With this arrangement the connecting pins are cut to a convenient length and are then bent upon one side of the portion reproducing the flattened tail, thereby proceeding very much like in the case of the incandescent lamps and thus obtaining an assembly being apt to allow to in a press-fit connect a light-emitting diode to a lampholder provided with resilient contacts and adapted to receive incandescent lamps. Such an assembly is furthermore apt to in a press-fit and in an easy and quick way be connected and disconnected as many times as necessary.

These and other characteristics will be best made apparent by the following detailed description referring to the accompanying drawings wherein:

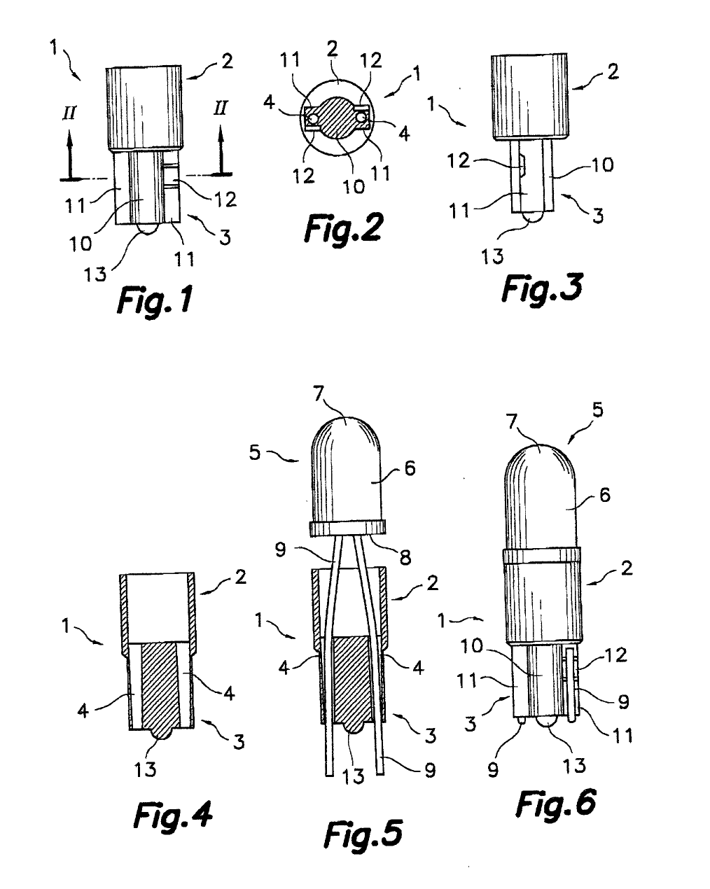

FIG. 1 is a front elevation of a member of the connecting device of the present invention;

FIG. 2 is a cross-sectional view as per section line II-II of FIG. 1,

FIG. 3 is a side view of the member of FIG. 1;

FIG. 4 is a longitudinal section of the member shown in FIG. 1,

FIG. 5 is a part-sectional elevation illustrating a stage in the process of fitting the member of FIG. 1 to a light-emitting diode; and

FIG. 6 is a front elevation of the device of the instant invention.

Referring now to the drawings, the device for connecting a light-emitting diode to a lampholder provided with resilient contacts comprises a member 1 made of a dielectric material and including a first hollow portion 2 and a second portion 3 externally reproducing configurations being characteristic of a flattened tail of an incandescent lamp (not shown) for which said lampholder with resilient contacts (not shown) is adapted.

FIG. 2 shows said member 1 with said first hollow portion 2 communicating with passages 4 longitudinally extending through said second portion 3 forming said flattened tail.

In order to carry out its function member 1 is fitted to a light-emitting diode 5 formed by a cylindrical body 6 capped at an end by a segment of a sphere 7, and at the other end ending in a flat surface 8 from which two connecting pins 9 extend and are passed first through said first hollow portion 2 (see FIG. 5) and then through the corresponding passages 4 of member 1. Once member 1 and light-emitting diode 5 have been completely fitted together, as shown in FIG. 6, the first hollow portion 2 of member 1 is abutting against said flat surface 8 of light-emitting diode 5, and connecting pins 9, having been cut to a convenient length, are bent upon one side of second portion 3 forming the flattened tail.

Said first hollow portion 2 is advantageously cylindrical on the outside and has a diameter that is substantially the same as that of cylindrical body 6 of light-emitting diode 5. The obtained assembly (see FIG. 6) does in this way externally reproduce the main shapes and dimensions of a conventional incandescent lamp, and is therefore apt to in a press-fit be connected/disconnected to/from said conventional lampholder provided With resilient contacts and adapted to receive incandescent lamps of standardized type.

Said characteristics of the flattened tail of an incandescent lamp which are reproduced by said second portion 3 comprise a central, longitudinal, enlarged area 10 flanked by two mutually opposite tabs 11 having said passages 4 extending through them to receive said connecting pins 9. Each of said tabs 11 is typically provided with at least one respective transverse notch 12. At the free end of said second portion 3 of member 1 is arranged a protruding stop 13 delimiting the depth for the insertion of the assembly into the lampholder.

In the exemplary embodiment illustrated in the figures each transverse notch 12 is located in an opposite side of the respective tab 11, as can be best appreciated in FIG. 2, each connecting pin 4 being bent upon those opposite sides of the respective tabs 11 incorporating the respective transverse notches 12.

The resilient contacts of the lampholder are thus resiliently and in a press-fit applied against said tabs 11 thus gripping and retaining the assembly while at the same time establishing an electric contact between connecting pins 9 and the terminals of the lampholder (not shown).

In an alternative exemplary embodiment (not shown) each tab 11 incorporates two transverse notches 12 in its mutually opposite faces, connecting pins 4 being bent upon transverse notches 12 of the opposite faces.

I claim:

1. A device for connecting a light-emitting diode to a lampholder provided with resilient contacts and of the type adapted to receive incandescent lamps comprising a glass-bulb and a flattened tail from which connecting pins extend; characterized in that it comprises a member (1) made of a dielectric material and including a first hollow portion (2) and a second portion (3) externally reproducing configurations of said flattened tail of that incandescent lamp for which said lampholder with resilient contacts is adapted, said first hollow portion (2) communicating with passages (4) longitudinally extending through said second portion (3) forming the flattened tail, said member (1) being fitted to a light-emitting diode (5) formed by a cylindrical body (6) capped at an end by a segment of a sphere (7), and at the other end ending in a flat surface (8) from which two connecting pins (9) extend and are passed first through said first hollow portion (2) and then through the corresponding passages (4) of member (1), said first hollow portion (2) of member (1) abutting against said flat surface (8) of light-emitting diode (5), and said connecting pins (9) being cut to a convenient length and being then bent upon one side of second portion (3) forming the flattened tail thus resulting in an assembly being apt to in a press-fit be connected/disconnected to/from said lampholder provided with resilient contacts and adapted to receive incandescent lamps.

2. A device as per claim 1, characterized in that said second portion (3) forming a flattened tail comprises a central, longitudinal, enlarged area (10) flanked by two mutually opposite tabs (11) having arranged through them said passages (4) provided to receive said connecting pins (9), each of said tabs (11) being provided with at least one respective transverse notch (12), a protruding stop (13) being arranged at the free end of said second portion (3) of member (1).

3. A device as per claim 2, characterized in that each of said passages (4) has at its end an inlet communicating with said first hollow portion (2), said inlet being wider than the outlet in order to thus facilitate the insertion of said connecting pins (9).

4. A device as per claim 2, characterized in that each tab (11) incorporates a transverse notch (12) in one of the faces opposite to the face of the other tab incorporating said transverse notch, each connecting pin (4) being bent upon a corresponding transverse notch (12).

5. A device as per claim 2, characterized in that each tab (11) incorporates two transverse notches (12) in its mutually opposite faces, said connecting pins (4) being bent upon transverse notches (12) of opposite faces.

6. A device as per any of the preceding claims, characterized in that said first hollow portion (2) is externally cylindrical and has a diameter being substantially the same as that of the cylindrical body (6) of said light-emitting diode (5).
